(19) United States
(12) Patent Application Publication
(10) Pub. No.: US 2007/0257749 A1
(43) Pub. Date: Nov. 8, 2007

(54) Coupling a signal through a window

(75) Inventors: Jonathan Gorrell, Gainesville, FL (US); Mark Davidson, Florahome, FL (US)

Correspondence Address: DAVIDSON BERQUIST JACKSON & GOWDEY LLP, 4300 WILSON BLVD., 7TH FLOOR, ARLINGTON, VA, 22203, US

(73) Assignee: Virgin Islands Microsystems, Inc., St. Thomas, VI (US)

(21) Appl. No.: 11/418,128

(22) Filed: May 5, 2006

(51) Int. Cl. H01P 7/06

(52) U.S. Cl. 333/227

(57) ABSTRACT

A device and method is provided that includes a window for coupling a signal between cavities of a device or between cavities of different devices. A wall or microstructure is formed on a surface and defines a cavity. The window is formed in the wall and comprises at least a portion of the wall and is electrically conductive. The cavity can be sized to resonate at various frequencies within the terahertz portion of the electromagnetic spectrum and generate an electromagnetic wave to carry the signal. The window allows surface currents to flow without disruption on the inside surface of the cavity.

### CROSS-REFERENCE TO RELATED APPLICATIONS

The present invention is related to the following co-pending U.S. Patent applications which are all commonly owned with the present application, the entire contents of each of which are incorporated herein by reference:
1. U.S. patent application Ser. No. 11/238,991, entitled “Ultra-Small Resonating Charged Particle Beam Modulator,” filed Sep. 30, 2005;
2. U.S. patent application Ser. No. 10/917,511, entitled “Patterning Thin Metal Film by Dry Reactive Ion Etching,” filed on Aug. 13, 2004;
3. U.S. application Ser. No. 11/203,407, entitled “Method Of Patterning Ultra-Small Structures,” filed on Aug. 15, 2005;
4. U.S. application Ser. No. 11/243,476, entitled “Structures And Methods For Coupling Energy From An Electromagnetic Wave,” filed on Oct. 5, 2005;
5. U.S. application Ser. No. 11/243,477, entitled “Electron beam induced resonance,” filed on Oct. 5, 2005;
6. U.S. application Ser. No. 11/325,448, entitled “Selectable Frequency Light Emitter from Single Metal Layer,” filed Jan. 5, 2006;
7. U.S. application Ser. No.11/325,432, entitled, “Matrix Array Display,” filed Jan. 5, 2006;
8. U.S. application Ser. No. 11/302,471, entitled “Coupled Nano-Resonating Energy Emitting Structures,” filed Dec. 14, 2005;
9. U.S. application Ser. No.11/325,571, entitled “Switching Micro-resonant Structures by Modulating a Beam of Charged Particles,” filed Jan. 5, 2006;
10. U.S. application Ser. No. 11/325,534, entitled “Switching Microresonant Structures Using at Least One Director,” filed Jan. 5, 2006;
11. U.S. application Ser. No. 11/350,812, entitled “Conductive Polymers for Electroplating,” filed Feb. 10, 2006;
12. U.S. application Ser. No. 11/349,963, entitled “Method and Structure for Coupling Two Microcircuits,” filed Feb. 9, 2006; and
13. U.S. application Ser. No. 11/353,208, entitled “Electron Beam Induced Resonance,” filed Feb. 14, 2006.

### COPYRIGHT NOTICE

A portion of the disclosure of this patent document contains material which is subject to copyright or mask work protection. The copyright or mask work owner has no objection to the facsimile reproduction by anyone of the patent document or the patent disclosure, as it appears in the Patent and Trademark Office patent file or records, but otherwise reserves all copyright or mask work rights whatsoever.

### FIELD Of THE DISCLOSURE

This relates in general to receivers for detecting optical signals and in particular to resonant structures detecting encoded optical signals.

### INTRODUCTION

The present device relates in general to coupling a signal in a vacuum environment and, more particularly, to coupling a signal through a window.

A device can be formed from a wall disposed on a substrate. The wall can be generally formed or enclosed about a space, which is referred to as a cavity. The cavity or resonant cavity can be used to perform various functions on a signal including mixing, amplifying, filtering and the like. The cavity can be represented by a parallel resonant LC circuit. The size of the cavity generally determines the resonant frequency. The cavity typically comprises a center portion and an outer portion, which is adjacent to the wall. Normally, the center portion is capacitive, and the outer portion is inductive. The signal within the resonant cavity can take the form of electric and magnetic fields. The signal is made up of oscillations and variation in those oscillations of the electric and magnetic fields. The outer portion is normally adjacent to the wall, and the electric fields can induce current on the wall of the cavity. This current on the wall is typically referred to as surface current. In response to the surface current or moving charges on the wall of the cavity, magnetic fields are normally formed inside of the current loop made by the charge moving along the wall of the cavity.

The device can include a plurality of walls forming distinct cavities. The various functions of such cavities, such as amplifying, can be performed by coupling the signal between cavities. For example, a feedback signal from a first cavity can control the amount of amplification in a second cavity. Methods of coupling the signal can include using a loop, a probe, a port or a tap. The loop couples the signal by employing a single loop of wire or a portion of wire through the wall of the device and into the cavity attached to the wall of the cavity in such a way that the oscillating magnetic field in the cavity has some magnetic flux through the loop. This generates a current in the loop proportional to the oscillating magnetic field. For the best coupling, the loop is typically attached to the wall at one end and positioned transverse to the strongest magnetic field. Another method such as the probe can include a single plate, which is not grounded. For best results, the plate is typically positioned transverse to the strongest electric field near the center portion of the cavity. The probe can be mechanically difficult to support, because the connection to the plate is on one end only. Further, arcing can occur where the electric field is the strongest. The port is another mentioned technique for coupling the signal and exposes the cavity via an opening in the wall. The amount of coupling is a function of the size of the port relative to the wavelength of the radiation and the position of the port. Tap coupling includes a direct connection to the cavity. All the mentioned techniques for coupling the signal generally disrupt the surface current, because of the inherent discontinuity of the inner surface of the wall to physically connect the loop, tap and probe. In the case of the port, the wall includes the opening, which disrupts the surface current. The discontinuity or gap can cause the surface current to radiate. This radiation typically generates spurious frequencies different from the cavity resonant frequency. The ratio of the energy of the signal stored in the cavity divided by the energy of the signal dissipated in the cavity is referred to as the Q of the cavity. All of the mentioned coupling techniques generally increase the energy losses within the cavity or reduce the Q of the cavity. For example, the penetrations through the wall of the cavity reduce the available path for currents flowing on the inner surface of the cavity. This increases the losses of the signal and reduces the available energy of the signal stored within the cavity.

Hence, there is a need for a device that can couple signals between cavities without the losses inherent with the mentioned coupling methods. We describe such a device in which a resonant cavity includes a wall with a corridor for coupling the signal.

### BRIEF DESCRIPTION OF THE DRAWINGS

FIG. 1 is an enlarged topped-off perspective-view of a coupling device;

FIG. 2a is a schematic diagram of the device in FIG. 1 illustrating energy transferred into the device and an electromagnetic wave transferred out of the device;

FIG. 2b is a schematic diagram of the device in FIG. 1 illustrating the electromagnetic wave transferred to the device and the energy transferred out of the device;

FIG. 2c and is schematic diagram of the device of FIG. 1 illustrating the frequency response of a window of the device;

FIG. 3 is an enlarged topped-off perspective-view of an alternative coupling device;

FIG. 4a is a schematic diagram illustrating energy coupled into a device and electromagnetic waves transferred in and out of the device;

FIG. 4b is a schematic diagram illustrating the electromagnetic waves transferred in and out of the device and the energy coupled out of the device;

FIG. 4c and is schematic diagram of the device of FIGS. 4a and 4b illustrating the response of a window;

FIG. 5 is an enlarged cross-sectional top-view illustrating the coupling of an electromagnetic wave through a window and out of a device;

FIG. 6 is an enlarged topped-off, perspective-view illustrating a device having two windows;

FIG. 7a is a schematic diagram illustrating energy coupled into a device and electromagnetic waves transferred out of the device;

FIG. 7b is a schematic diagram illustrating the electromagnetic waves transferred into the device and the energy coupled out of the device;

FIG. 8a is a schematic diagram illustrating energy coupled into a device and electromagnetic waves having two frequencies transferred into and out of the device;

FIG. 8b is a schematic diagram illustrating the electromagnetic waves transferred into and out of the device and the energy coupled out of the device;

FIG. 8c is a diagram illustrating the response of transferred energy of an electromagnetic wave through a first window of the device in FIGS. 8a and 8b;

FIG. 8d is a diagram illustrating the response of transferred energy of an electromagnetic wave through a second window of the device in FIGS. 8a and 8b; and

FIG. 9 is an enlarged topped-off, perspective-view of a device illustrating coupling an electromagnetic wave between two cavities.

### DETAILED DESCRIPTION OF THE DRAWINGS

Methods of making a device for detecting an electromagnetic wave are described in U.S. application Ser. No. 10/917,511, filed on Aug. 13, 2004, entitled “Patterning Thin Metal Film by Dry Reactive Ion Etching,” and U.S. application Ser. No. 11/203,407, filed Aug. 15, 2005, entitled “Method of Patterning Ultra-small Structures,” each of which is commonly owned at the time of filing, and the entire contents of each are incorporated herein by reference.

Using these techniques, a structure for coupling a signal to and from a cavity of a device can be manufactured, as described for example in one or more of the following applications, each of which are incorporated by reference:
14. U.S. patent application Ser. No. 11/238,991, entitled “Ultra-Small Resonating Charged Particle Beam Modulator,” filed Sep. 30, 2005;
15. U.S. application Ser. No. 11/243,476, entitled “Structures And Methods For Coupling Energy From An Electromagnetic Wave,” filed on Oct. 5, 2005;
16. U.S. application Ser. No. 11/243,477, entitled “Electron beam induced resonance,” filed on Oct. 5, 2005;
17. U.S. application Ser. No. 11/325,448, entitled “Selectable Frequency Light Emitter from Single Metal Layer,” filed Jan. 5, 2006;
18. U.S. application Ser. No. 11/325,432, entitled, “Matrix Array Display,” filed Jan. 5, 2006;
19. U.S. application Ser. No. 11/302,471, entitled “Coupled Nano-Resonating Energy Emitting Structures,” filed Dec. 14, 2005;
20. U.S. application Ser. No. 11/325,571, entitled “Switching Micro-resonant Structures by Modulating a Beam of Charged Particles,” filed Jan. 5, 2006;
21. U.S. application Ser. No. 11/325,534, entitled “Switching Microresonant Structures Using at Least One Director,” filed Jan. 5, 2006;
22. U.S. application Ser. No. 11/350,812, entitled “Conductive Polymers for Electroplating,” filed Feb. 10, 2006;
23. U.S. application Ser. No. 11/349,963, entitled “Method and Structure for Coupling Two Microcircuits,” filed Feb. 9, 2006;
24. U.S. application Ser. No. 11/353,208, entitled “Electron Beam Induced Resonance,” filed Feb. 14, 2006; and
25. U.S. application Ser. No. 11/400,280, entitled “Resonant Detector for Optical Signals,” filed Apr. 10, 2006.

Such a device can include a microstructure formed by a wall. The wall can be formed by stacking layers of material on a surface and can form a substantially closed geometric configuration that defines or encloses the cavity. An electrically conductive window or plurality of windows can be formed in the wall. An electromagnetic wave either generated within the cavity or provided from an outside source can be coupled in and out of the cavity through the window. The outside source can include another location within the device. The electromagnetic wave can carry a signal and have a frequency range from about 0.1 terahertz (THz) (3000 microns) to about 7 petahertz (PHz) (0.4 nanometers), referred to as the terahertz portion of the electromagnetic spectrum. Under such an influence, surface current typically forms on an inner surface of the cavity. Unlike other coupling methods, the window, which is electrically conductive, allows conduction of the surface current. This provides the advantage of not disrupting the surface current and the resonance of the cavity.

In an alternate embodiment, a device can include a focusing element coupled to the window. The focusing element collects the electromagnetic wave carrying the signal. Further, a waveguide or an optical fiber can be coupled to the focusing element and can be used to route the signal to a particular location.

In another alternate embodiment, a device can include at least two walls or microstructures and each microstructure can contain at least one window. A waveguide or optical fiber can be used to couple a feedback signal between the windows.

In yet another alternate embodiment, a device can include a window that filters particular frequency ranges of the electromagnetic wave carrying the signal. The filtering can include limiting frequencies above or below a particular critical frequency.

The present invention will be better understood from a reading of the following detailed description, taken in conjunction with the accompanying drawing figures, in which like reference numbers designate like elements and in which:

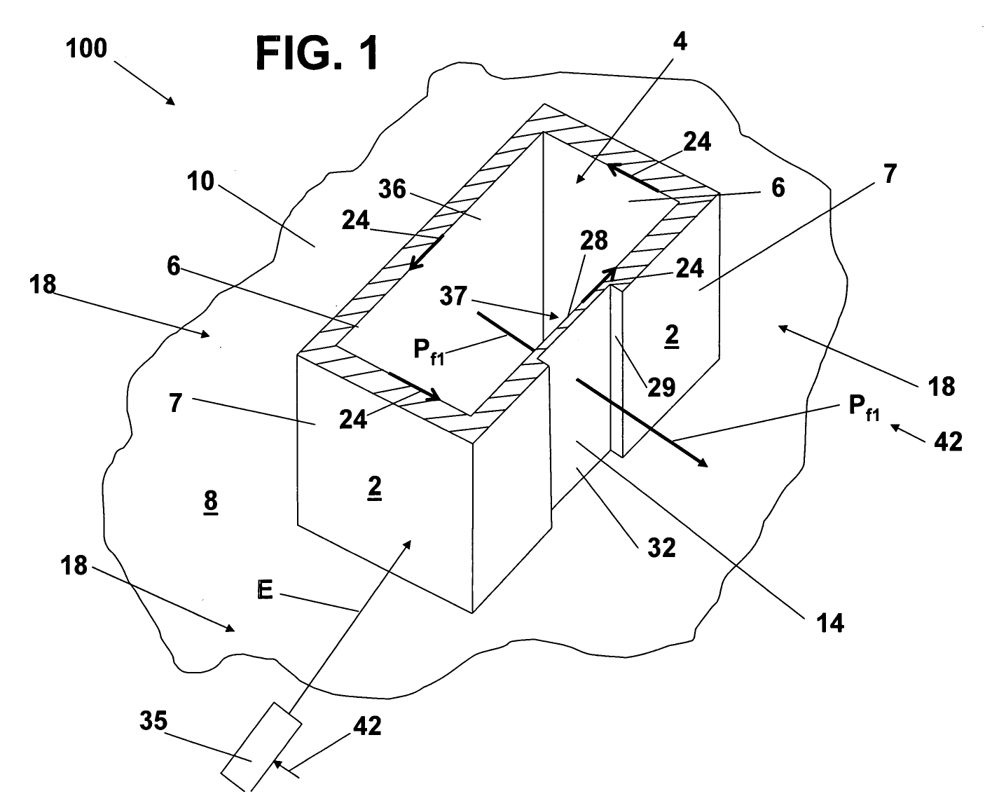

FIG. 1 is an enlarged topped-off, perspective view illustrating a coupling device 100. In FIG. 1, the device 100 comprises a wall 2. The wall 2 can include a microstructure or a portion of a microcircuit and can be formed by stacking layers of material on a surface 10 of a substrate 8. The surface can be flat as in FIG. 1, or may be any other flat or non-flat wall-shaped configuration. The surface can be on a substrate or other structure and may be in unusual locations, such as on fiber ends or on filaments. The number of layers of the wall 2 and method of forming the wall 2 should not be considered limitations of the present invention. The wall 2 can form a substantially closed geometric configuration that defines or encloses or partially encloses a cavity 4. The substrate 8 can include all or a portion of a microcircuit made of semiconductor materials, ceramics, plastics, metals and the like. Even though the device 100 is shown generally cubical with the wall 2 straight, the device 100 can include a shape that is spherical, c-shaped, triangular-pyramidal or other shape that has the desired resonant frequency characteristics. The shape should not be considered a limitation of the present invention. The device 100 and the cavity 4 can be sized to the resonant wavelength, sub-wavelength, and multiples of the operating wavelength.

The wall 2 can be made of a material having a strong interaction with plasmons at the frequency of operation of the device 100. Plasmons can include bulk plasmons and surface plasmons, which are plasma oscillations or charge density waves. Surface plasmons refer to those charge density waves confined to an interface of a material with sufficiently free electrons and a dissimilar material. This strong interaction can include using metals having a plasma frequency covering at least a portion of the optical and/or terahertz spectrum, depending on the application frequency. The plasma frequency is dependant upon the type of material used. For example, the plasma frequency of silver includes a range from the visible portion of the electromagnetic spectrum to the infrared. Hence, there is a strong interaction between silver and an electromagnetic wave within the above frequency range. The wall 2 can be made using materials such as gold, silver, copper, aluminum and the like.

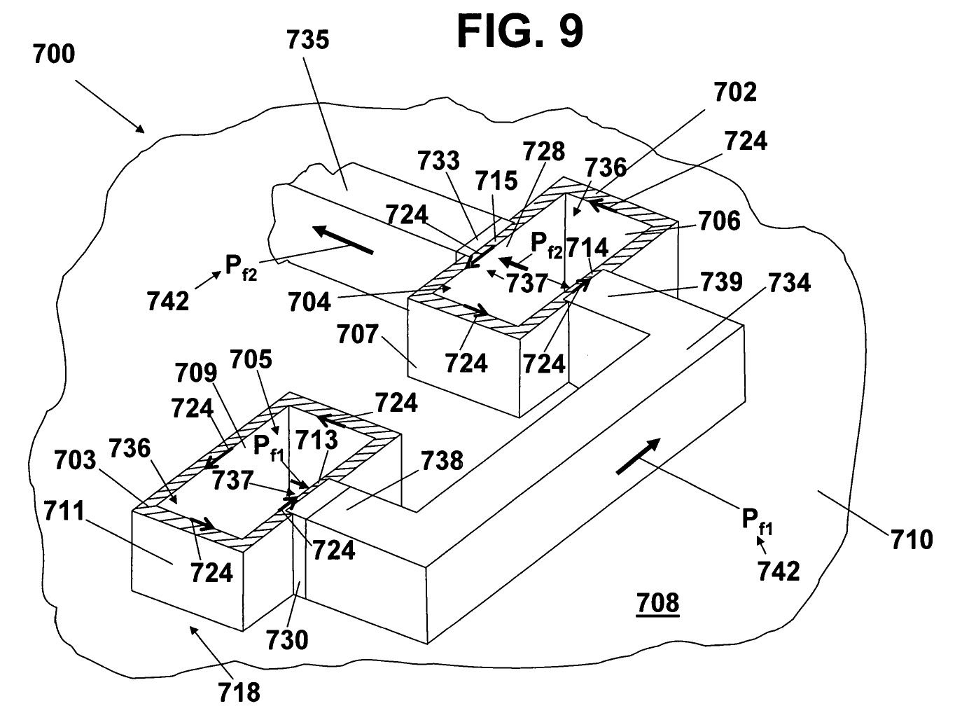

An outer surface 7 of the device 100 or the wall 2 can be exposed to a space 18, such as a vacuum or a gas or a solid dielectric. As shown, energy (E as shown in FIG. 1) such as an electromagnetic wave can be provided from an outside source 35. The outside source 35 can include another portion of the device as discussed later under FIG. 9. The energy (E) can be coupled across the space 18 to the outer surface 7. This provides a permittivity or dielectric shift of the energy, (E) because of the transition across the space 18 to the outer surface 7, which typically comprises a metal. A plasmon mode or a stimulation of the plasmons is caused by an interaction between the energy (E) and free-electrons on the outer surface 7. This results in a plasmon mode or a stimulation of the plasmons on the outer surface 7 of the wall 2. In some cases, particularly at lower frequencies, the Plasmon mode is not active and the charge transport occurs by more typical conduction mechanisms. Varying fields inherently occur on stimulation of the plasmons or other charge density fluctuations. Further, a signal 42 coupled to the outside source 35 can be carried on the energy (E) or electromagnetic wave coupled to the device 100. The remainder of the discussion will refer to Plasmon waves, but it is to be understood that the effects are also applicable to the more general case of charge density waves.

An inner surface 6 is the side of the wall 2 exposed to the cavity 4. Plasmons having varying fields are stimulated on the outer surface 7 and can be coupled through the wall 2 to the inner surface 6. The energy from the varying fields can be stored in the cavity 4 or intensified if another source of energy is provided. Electric and magnetic fields are generated within the cavity 4. This can result in accelerating charges on the inner surface 6 of the cavity 4. Further, the varying fields can include a time-varying electric field component across the cavity 4. Thus, similar to an antenna, an electromagnetic wave P_{f1} can be generated in the cavity 4. Further, the magnetic fields within the cavity 4 excite a surface current 24 on the inner surface 6 of the device 100.

In FIG. 1, a window 14 is shown formed in the wall 2 of the device 100. The window 2 is electrically conductive or made of a material that supports the necessary charge density wave and may be made from the wall 2. The window 14 and the wall 2 are illustrated by the topped-off view in FIG. 1 as having distinctive thicknesses. The thickness of the window 14 is typically substantially less than the thickness of the wall 2. In one example, the thickness of the window 14 is less than 10 nanometers. In another example, the thickness of the window 14 can be less than the penetration depth (δ). For a time-varying current, the current density through a conductor varies exponentially as a function of a depth into the conductor. By convention, a penetration depth (δ) is defined as the depth where the current density is 36.78 percent (1/ε or one divided by 2.7182) of the current density at the surface of the conductor. The penetration depth can be calculated by:

$$δ = \frac{1}{\sqrt{π f μ σ}} \qquad Equation 1$$

The variables of equation 1 include f, σ and μ, which are the frequency of the time-varying current, the conductivity of the conductor, and the permeability of the conductor, respectively. For example, the penetration depth (δ) for copper at a frequency of 1 terahertz is about 66 nanometers.

The window 14 can be made to allow the electromagnetic wave P_{f1} to partially pass through. This permits coupling of the electromagnetic wave P_{f1} in or out of the cavity 4 through the window 14. The window 14 can have a thickness less than, greater than, or equal to the penetration depth (δ). Generally, the window 14 can pass the electromagnetic wave P_{f1} with reflection or absorption of less than a few percent and can be referred to as generally transparent. In another embodiment, the window 14 can partially reflect or absorb the electromagnetic wave P_{f1} and can be called translucent. It should be noted that the amount of scattering through the window 14 can be a function of the type of material and/or processing used to make the window 14. Further, the transmittance is dependant upon the thickness of the window 14 and the wavelength of the electromagnetic wave P_{f1}. For example, the window 14 made of silver and having a thickness of about 10 nanometers has a transmittance of about 95 percent in the visible portion of the electromagnetic spectrum. Further yet, the window 14 can be made to pass particular frequencies. For example, the window 14 can function as a low-pass, high-pass, band-pass or band-stop filter. The thickness of the window 14 in combination with the type of material used to make the window 14 can establish a particular range of frequencies passed by the window 14. The transmittance of the window 14 can include a range from about zero percent to about 99.9 percent.

A surface or portion of the window 14 is exposed to or adjacent to the cavity 4. This portion of the window 14 adjacent to the cavity 4 can include the entire inner surface 6 and is referred to as a portion of the inner surface 28. The portion of the inner surface 28 of the window 14 can be generally flush with the inner surface 6 of the cavity 4. As mentioned above, surface current 24 is induced on the inner surface 6 by varying electric and magnetic fields. When disrupted by a discontinuity or gap, the surface current 24 generates spurious radiation. Since there is no discontinuity between the portion of the inner surface 28 and the inner surface 6, the surface current 24 does not radiate. This provides a distinct advantage over the prior art.

An area 36 includes the entire inner surface 6. An area 37 includes the portion of the inner surface 28. The area 37 includes between about 1 percent to about 100 percent of the area 36.

A step 29 can be formed on the outer surface 7. A portion of the outer surface 7 that forms the window 14 is called an outside surface 32. The step 29 can be formed between the outside surface 32 and the outer surface 7. The step 29 can be abrupt or can taper or form a graded transition between the outside surface 32 and the outer surface 7.

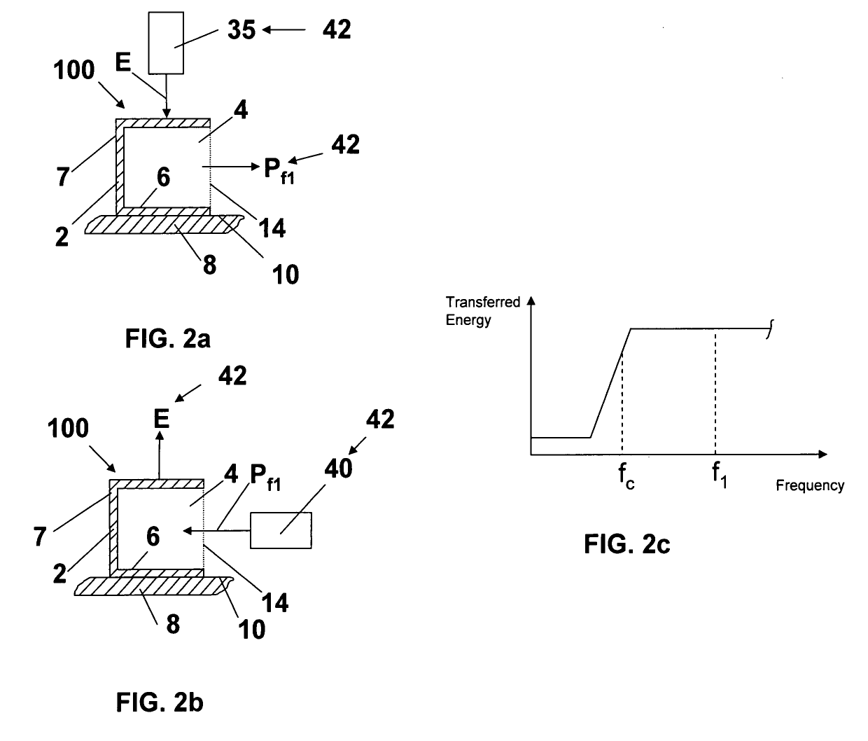

FIGS. 2a and 2b are schematic diagrams illustrating the device 100 formed from the wall 2 that defines or encloses the cavity 4. In FIGS. 2a and 2b, plasmons are stimulated at the outer 7 and inner 6 surfaces of the wall 2, respectively. In FIG. 2a, energy (E) is provided to the outer surface 7 by the outside source 35. Plasmons and varying fields are stimulated on the outer surface 7. The energy (E) is represented by an arrow pointing toward the device 100 and can be modulated to carry the signal 42. The net flow of energy (E) including stimulated plasmons and varying fields are coupled through the wall 2 from the outer 7 to the inner 6 surface. An electromagnetic wave P_{f1} is generated in the cavity 4. The electromagnetic wave P_{f1} can include frequencies distributed over a range of frequencies centered about a frequency f1. As shown in FIG. 2c, the window 14 can be made to pass frequencies above a particular critical frequency f_{c} including frequency f₁ of the electromagnetic wave P_{f1}. This allows the electromagnetic wave P_{f1} carrying the signal 42 to couple out of the device 100 through the window 14. In FIG. 2b, the electromagnetic wave P_{f1}, now provided from an outside source 40 modulated by the signal 42, is coupled through the window 14 and into the cavity 4 of the device 100. Plasmons are stimulated on the inner surface 6. The energy (E) in the form of plasmons and varying fields can be coupled through the wall 2 from the inner 6 to the outer 7 surface. Since the net flow of energy (E) is from the inner surface 6, the arrow in FIG. 2b is now shown pointing away from the device 100.

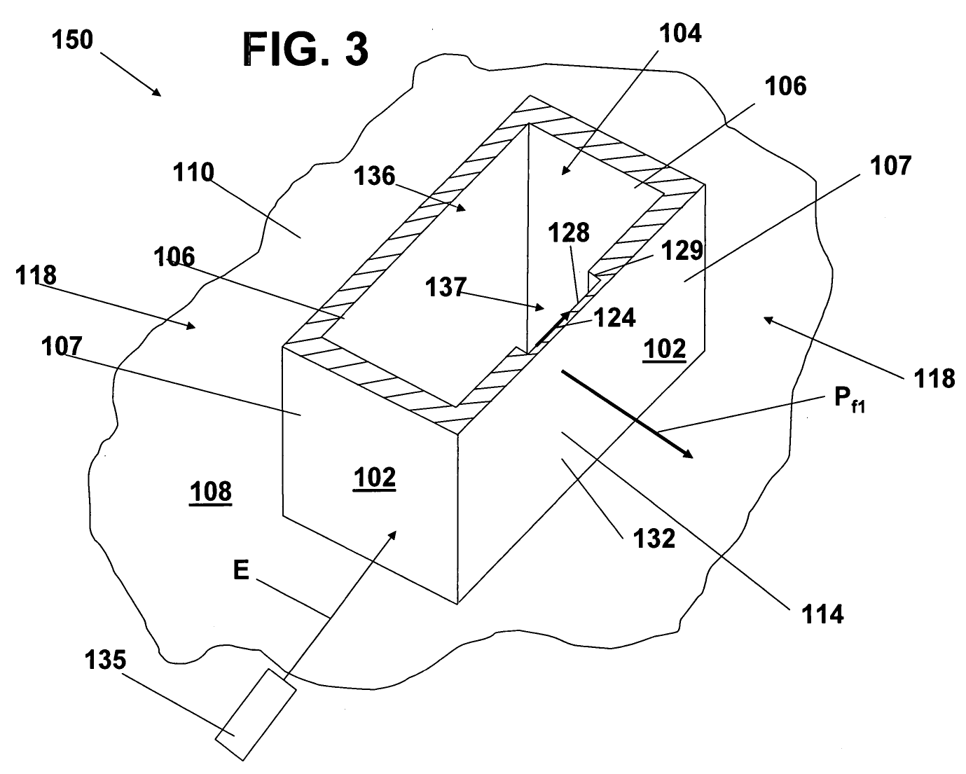

FIG. 3 is an enlarged topped-off, perspective view showing a coupling device 150. FIG. 3 illustrates a wall 102 disposed on a major surface 110 of a substrate 108, and the wall 102 is formed about a cavity 104. An inner surface 106 of the wall 102 is exposed to the cavity 104. A window 114 is formed in the wall 102 and as shown has a thickness generally less than the thickness of the wall 102. A surface or portion of the window 114 is exposed to or adjacent to the cavity 104. This portion of the window 114 can include the entire inner surface 106 and is referred to as a portion of the inner surface 128. In this embodiment, a step 129 is included on the inner surface 106 between the portion of the inner surface 128 and the inner surface 106. The step 129 can be abrupt or can taper or form a graded transition between the portion of inner surface 128 and the inner surface 106.

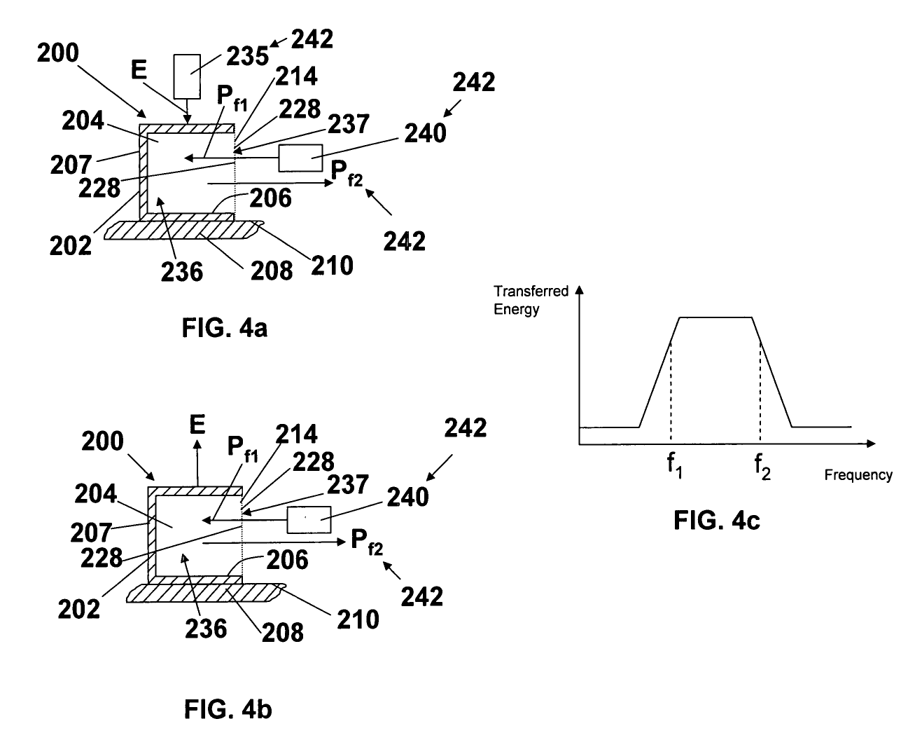

FIGS. 4a and 4b are schematic diagrams illustrating the device 200 formed from the wall 202 that defines or encloses the cavity 204. In FIGS. 4a and 4b, plasmons are stimulated at the outer 207 and inner 206 surfaces of the wall 202, respectively. In FIG. 4a, energy (E) is provided to the outer surface 207 by an outside source 235. The outside source 235 can include another portion of the device as discussed later under FIG. 9. The energy (E) can be modulated by a signal 242 coupled to the outside source 235. Plasmons and varying fields are stimulated on the outer surface 207. The energy (E) is represented by an arrow pointing toward the device 200. This is because the net flow of energy (E) including stimulated plasmons and varying fields are coupled through the wall 202 from the outer 207 to the inner 206 surface. Also, an electromagnetic wave P_{f1} is received through a window 214 into the cavity 204 from an outside source 240. The outside source 240 can include another portion of the device 200. The energy (E) can be modulated by a signal 242 coupled to the outside source 240. The window 214 is electrically conductive and made from the wall 202. The electromagnetic wave P_{f1} carrying the signal 242 can include frequencies distributed over a range of frequencies centered about a frequency f1. The electromagnetic wave P_{f1} further stimulates plasmons and varying fields on the inner surface 206. An electromagnetic wave P_{f2} having frequencies distributed over a range of frequencies centered about a frequency f2 is generated in the cavity 204 from the stimulated plasmons and varying fields on the inner surface 206. The electromagnetic wave P_{f2} carrying the signal 242 is coupled through the window 214 and out of the cavity 204. As shown in FIG. 4c, the window 214 is made to pass frequencies over a range of frequencies including f₁ and f₂. This allows the electromagnetic waves P_{f1} and P_{f2} to pass through or couple through the window 214 and into and out of the cavity 204, respectively. In FIG. 4b, the electromagnetic wave P_{f1} carrying the signal 242 is again received through the window 214 into the cavity 204 from the outside source 240. Plasmons and varying fields are stimulated on the inner surface 206. As shown in FIG. 4b, an arrow (E) is pointing away from the device 200, because the net flow of energy (E) is through the wall 202 from the inner 206 to the outer 207 surface.

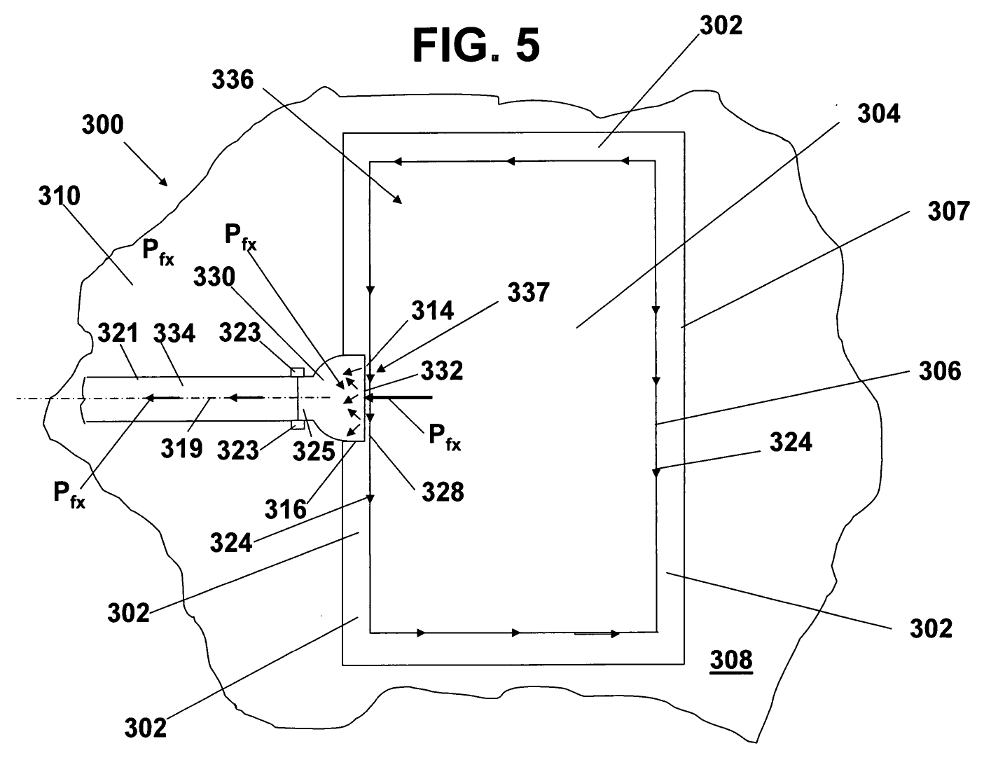

FIG. 5 is an enlarged cross sectional top-view illustrating another alternative coupling device 300. The device 300 includes a wall 302 formed on a surface 310 of a substrate 308. The wall 302 includes inner 306 and outer 307 surfaces and is formed about a cavity 304. The inner surface 306 is exposed to the cavity 304.

A window 314 is formed in the wall 302 similar to FIG. 1. The window 314 is electrically conductive and made from the wall 302. The window 314 is generally thinner than a portion of the wall 302 not containing the window 314. A surface or portion of the window 314 is exposed to or adjacent to the cavity 304. This portion of the window 314 adjacent to the cavity 304 can include the entire inner surface 306 and is called a portion of the inner surface 328. The surface of the window 314 opposite the portion of the inner surface 328 is referred to as the outside surface 332. As mentioned previously under FIG. 1, surface current 324 can be induced by magnetic fields on the inner surface 306. Similar to FIG. 1, the inner surface 306 and the portion of the inner surface 328 are generally flush and provide a continuous path without disrupting the path of the surface current 324.

An indentation 316 can be formed on the outer surface 307 and can include the outside surface 332 of the window 314. As shown in FIG. 5, an electromagnetic wave P_{fx} passes or couples through the window 314 and out of the cavity 304. The path of the electromagnetic wave P_{fx} can be scattered or travel on a plurality of paths including paths nearly parallel to the outside surface 332 of the window 314.

A collector 330 can be positioned to fill the indentation 316 and may contact the outside surface 332 of the window 314. The collector 330 reduces the scatter or alters the plurality of paths such that the electromagnetic wave P_{fx} travels generally parallel to a centerline 319 shown in FIG. 5 extending from the collector 330. As shown in FIG. 5, the collector 330 can include a protruding portion 325 to connect to other structures and can include a collimator (not shown). The collector 330 can be made using materials including plastic, glass and the like or could be a waveguide type structure. The collector 330 can be made using materials having a combination of refractive indexes for directing the electromagnetic wave P_{fx} along a path generally parallel to the centerline 319. Further, the collector 330 can include a layer (not shown) or a plurality of layers of alternating refractive indexes to limit reflections. The layer(s) can be formed using chemical vapor deposition, which is well known in the art.

A wave coupler 334 can be connected to the collector 332 and is used to couple the electromagnetic wave P_{fx} from the collector 330. The wave coupler 334 can be formed to the collector 330 using established semiconductor processing methods. In another embodiment (as shown), a ferrule 323 can be used to align and couple between the protruding portion 325 of the collector 330 and the wave coupler 334. The technique for coupling the collector 330 to the wave coupler 334 should not be considered a limitation to the present invention. The wave coupler 334 can include a dielectric waveguide made of a dielectric material or multiple layers of materials. The dielectric materials can include plastic, glass, various gasses such as air and the like. Further, the wave coupler 334 can include a hollow silica waveguide. For frequencies in the infrared portion of the electromagnetic spectrum, an inside wall 321 of the wave coupler 334 can include silver in combination with a dielectric reflector. The type of construction of the wave coupler 334 should not be considered a limitation of the present invention.

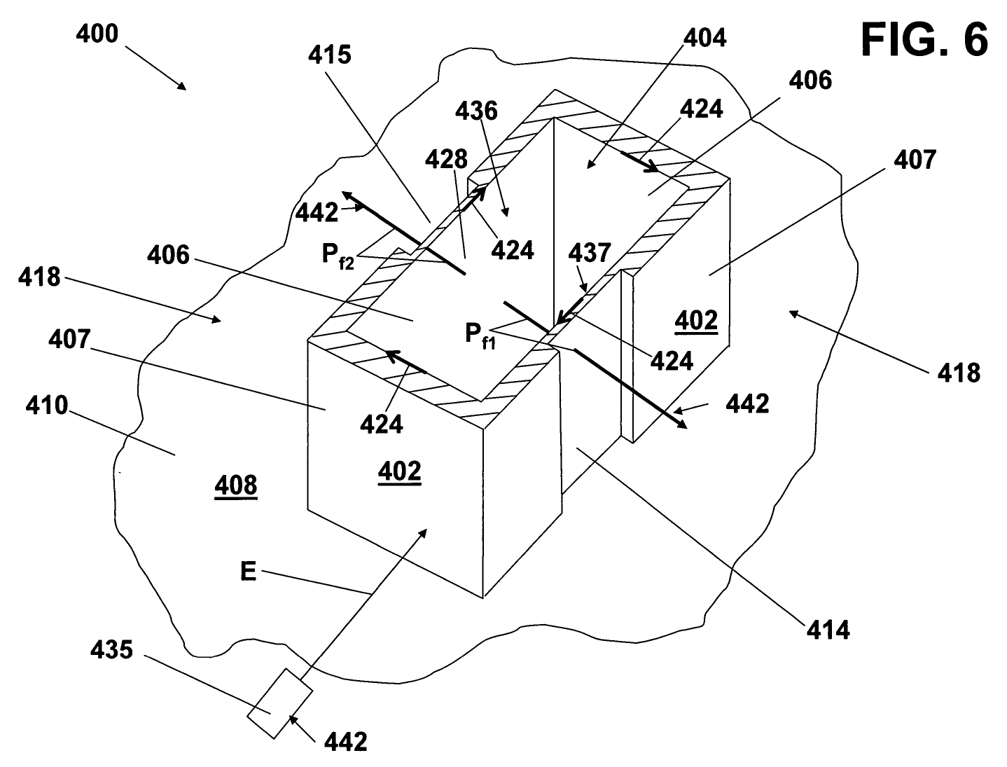

FIG. 6 is an enlarged topped-off, perspective-view illustrating a device 400 in accordance with another embodiment of the present invention. FIG. 6 illustrates the, device 400 comprising a wall 402 formed on a major surface 410 of a substrate 408. Similar to FIG. 1, the substrate 408 can be made of semiconductor materials, ceramics, plastics, metals and the like. The wall 402 includes inner 406 and outer 407 surfaces and is formed about a cavity 404. The inner surface 406 is exposed to the cavity 404. The wall 402 can be made with materials having a strong interaction with plasmons such as gold, silver, copper, aluminum and the like or a material that most easily supports charge density oscillations at the desired frequency range. The shape and size of the device 400 can be similar to device 100 under FIG. 1.

Windows 414 and 415 made from the wall 402 are disposed in the wall 402 and are electrically conductive. A surface or portion of the windows 414 and 415 is exposed to or adjacent to the cavity 404. This portion of the windows 414 and 415 can include the entire inner surface 406 and is referred to as a portion of the inner surface 428.

As shown in FIG. 6, energy (E) can be imparted to an outer surface 407 of the device 400 from an outside source 435. The outside source 435 can include another portion of the device as discussed later under FIG. 9. The energy (E) can be modulated by a signal 442 coupled to the outside source 435. Plasmons having varying fields can be stimulated by the energy (E) on the outer surface 407. The stimulated plasmons and varying fields can be coupled through the wall 402 from the outer 407 to the inner 406 surface. Surface current 424 is shown generated on the inner surface of the wall 402. Electromagnetic waves P_{f1} and P_{f2} carrying the signal 442 are generated within the cavity 404.

The windows 414 and 415 can be made to couple or pass electromagnetic waves. In particular, the windows 414 and 415 can be made to couple electromagnetic waves having distinct frequency ranges. For example, window 414 can be made to couple or pass the electromagnetic wave P_{f1} having a frequency range from about 100 to about 600 terahertz. And, window 415 can be made to pass the electromagnetic wave P_{f2} having a frequency range from about 800 terahertz to about 1000 terahertz. In a second example, the window 414 can be made to couple the electromagnetic wave P_{f1} within the terahertz spectrum having a frequency below about 100 terahertz. Continuing the second example, the window 415 can be made to pass the electromagnetic wave P_{f2} within the terahertz spectrum having a frequency above about 600 terahertz. It may also be possible to achieve this response using plasmon response versus frequency of the material. The respective examples can be referred to as pass-band and cutoff filtering methods.

In another example, a thin layer of silver acts as an Infrared blocking coating on the window while passing visible light. In general, higher frequency radiation corresponds to a smaller skin penetration depth and less transmission through the thin material.

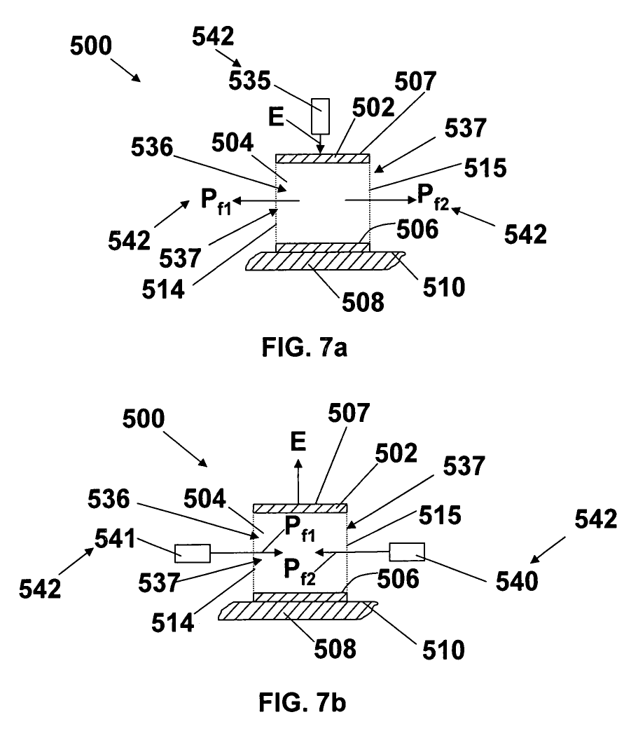

FIGS. 7a and 7b are schematic diagrams illustrating alternative coupling devices 500. The device 500 is formed from a wall 502 that defines or encloses a cavity 504 and includes at least one window that forms at least a portion of the wall 502. In FIGS. 7aand 7b, plasmons can be stimulated from the outer 507 and inner 506 surfaces of the wall 502, respectively. In FIG. 7a, energy (E) is provided on the outer surface 507 by an outside source 535. The outside source 535 can include another portion of the device as discussed later under FIG. 9. The energy (E) can be modulated by a signal 542 coupled to the outside source 535. The energy arrow (E), as shown in FIG. 7a, is pointing toward the cavity 504, because the net energy transfer from the inner surface 506 to the outer 507 surface is generally toward the cavity 504. Plasmons having varying fields are stimulated by the energy (E) on the outer surface 507. The stimulated plasmons and varying fields are coupled through the wall 502 from the outer surface 507 to the inner surface 506. Electromagnetic waves P_{f1} and P_{f2} carrying the signal 442 are generated within the cavity 504. Electromagnetic waves P_{f1} and P_{f2} include distinct frequency ranges centered about frequencies f1 and f2, respectively.

Windows 514 and 515 made from the wall 502 are formed in the wall 502 and are electrically conductive. Further, the windows 514 and 515 can be made to couple or pass electromagnetic waves having distinct frequency ranges. For example, windows 514 and 515 can be made to pass the electromagnetic waves P_{f1} and P_{f2}, respectively. In FIG. 7b, the electromagnetic waves P_{f1} and P_{f2} now provided from respective outside sources 541 and 540, which can be modulated by the signal 542. The outside sources 540 and 541 can include other portions of the device as discussed later under FIG. 9. The electromagnetic waves P_{f1} and P_{f2} can be coupled through the respective windows 514 and 515. Plasmons having varying fields are stimulated on the inner surface 506. As shown, energy (E) in the form of plasmons and varying fields can be coupled through the wall 502 from the inner surface 506 to the outer surface 507.

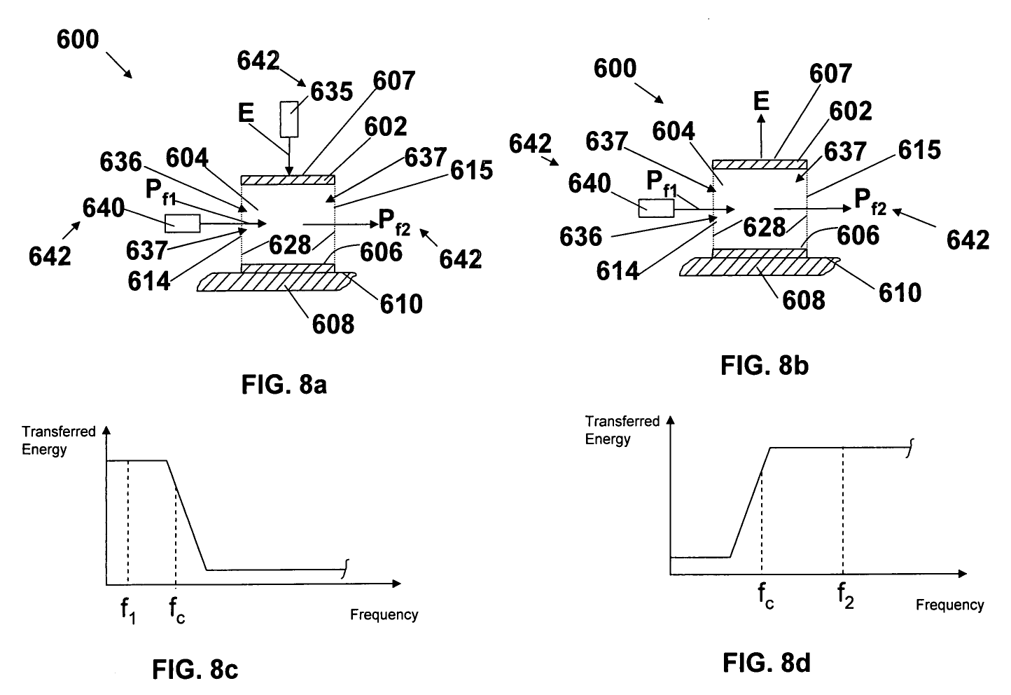

FIGS. 8a and 8b are schematic diagrams illustrating another coupling device 600. The device 600 is formed from a wall 602 that defines or encloses a cavity 604 and includes windows 614 and 615. The windows 614 and 615 made from the wall 602 are formed in the wall 602 and are electrically conductive. In FIGS. 8a and 8b, plasmons can be stimulated at the outer 607 and inner 606 surfaces of the wall 602, respectively. In FIG. 8a, energy (E) is provided on the outer surface 607 by an outside source 635. The outside source 635 can include another portion of the device as discussed later under FIG. 9. The energy (E) can be modulated by a signal 642 coupled to the outside source 635. The energy (E) arrow, as shown in FIG. 8a, is pointing toward the cavity 604, because plasmons having varying fields are stimulated by the energy (E) on the outer surface 607. The stimulated plasmons and varying fields are coupled through the wall 602 from the outer surface 607 to the inner surface 606. The net energy transfer is generally toward the cavity 604. Further, an electromagnetic wave P_{f1} having a distinct frequency range centered about frequency f1. Is provided from an outside source 640, which can be modulated by the signal 642. The outside source 640 can include another portion of the device as discussed later under FIG. 9.

FIG. 8c is a diagram illustrating the response of the transferred energy of an electromagnetic wave through the window 614 in FIGS. 8a and 8b. Frequency f_{c} is a cut-off frequency of the window 614, and electromagnetic waves having frequencies below about f_{c} are generally coupled or passed through the window 614

In FIG. 8a, the electromagnetic wave P_{f1} including a range of frequencies centered below the frequency f_{c} is coupled through the window 614 and into a cavity 604 of the device 600. This further stimulates plasmons and varying fields on the inner surface 606. In response to the stimulation of the plasmons, the electromagnetic wave P_{f2} carrying the signal 642 is generated in the cavity 604 and has a distinct frequency range centered about frequency f2.

FIG. 8d is a diagram illustrating the response of the transferred energy of an electromagnetic wave through the window 615 in FIGS. 8a and 8b. Frequency f_{c} is a cut-off frequency of the window 615 and electromagnetic waves having frequencies above about f_{c} are generally coupled or passed through the window 615.

In FIG. 8a, the electromagnetic wave P_{f2} having a frequency f₂ above f_{c} couples out of the cavity 604 through the window 615.

In FIG. 8b, the electromagnetic wave P_{f1} carrying the signal 642 is provided from the outside source 640 and coupled through the window 614 into the cavity 604. Plasmons having varying fields are stimulated on the inner surface 606. As shown in FIG. 8b, the energy (E) arrow is pointing from the cavity 604, because the plasmons and varying fields are generally coupled through the wall 602 from the inner surface 606 to the outer surface 607. Further, the electromagnetic wave P_{f2} carrying the signal 642 is generated within the cavity 604. The electromagnetic wave P_{f2} couples out of the cavity 604 through the window 615.

FIG. 9 is an enlarged topped-off, perspective-view illustrating another coupling device 700. By topped-off one should not presume that the inventions described herein necessarily require tops. In some embodiments, the device will have no top. FIG. 9 illustrates the device 700 comprising walls 702 and 703 typically formed apart and on a surface 710 of a substrate 708. Similar to FIG. 1, the substrate 708 can be made of semiconductor materials, ceramics, plastics, metals and the like. The walls 702 and 703 are substantially closed geometric structures and define or enclose cavities 704 and 705, respectively. Inner surfaces 706 and 709 of the respective walls 702 and 703 are exposed to the cavities 704 and 705, respectively. The walls can be made of materials having a strong interaction with plasmons or other surface charge density wave such as gold, silver, copper, aluminum and the like.

A window 713 is disposed in the wall 703 and made from the wall 703 and is electrically conductive. Similarly, windows 714 and 715 are electrically conductive and made from and disposed on wall 702. A surface or portion of the windows 713, 714 and 715 is exposed to or adjacent to their respective cavities 704 and 705. This portion of the windows 713, 714 and 715 can include the entire respective inner surfaces 706 and 709 and is referred to as a portion of the inner surface 728.

The walls 702 and 703 include respective outer surfaces 707 and 711. Plasmons or other charge density waves having varying fields can be stimulated using at least two methods. As mentioned previously, plasmons having varying fields can be stimulated by applying energy on the outer surface, such as outer surfaces 707 and 711. This energy can be applied using an electromagnetic wave and carry a signal. The electromagnetic wave can be provided from the device 700 or from an outside source (not shown). A second method of stimulating plasmons having varying fields includes coupling the electromagnetic wave between cavities such as between cavities 704 and 705. This second method (described below) provides the advantage of applying various functions on the device 700 such as mixing, amplifying, filtering and the like.

Plasmons having varying field are stimulated on the inner surface 709 of cavity 705. Fields are generally intensified across the cavity 705. Surface current 724 is formed on the inner surface 709. As mentioned previously, the surface current such as the surface current 724 is not disrupted, because the portion of the inner surface 728 of the window 713 is generally flush with the inner surface 709 of the cavity 705. An electromagnetic wave P_{f1} carrying a signal 742 is generated in cavity 705 and has a particular frequency distribution over a range of frequencies centered about a frequency f1. The window 713 can be made to selectively pass or couple distinct frequency ranges such as the particular frequency distribution centered about f1. The electromagnetic wave P_{f1} is coupled out of the cavity 705 through the window 713.

Collectors 730 and 733 are shown in FIG. 9 adjacent to the respective windows 713 and 715. As mentioned under FIG. 5, the collectors 730 and 733 are used to reduce the scatter of an electromagnetic wave. The electromagnetic wave P_{f1} emitted from the window 713 is coupled into the collector 730 to reduce scatter.

A wave coupler 734 is shown coupled between the windows 713 and 714. The wave coupler 734 can be made similar to the description as mentioned under FIG. 5 and can include a dielectric waveguide. From the collector 730, the electromagnetic wave P_{f1} travels along the wave coupler 734. Next, the window 714 selectively passes the electromagnetic wave P_{f1} into the cavity 704. The coupling of the electromagnetic wave P_{f1} into the cavity 704 from the wave coupler 734 is an example of coupling from another portion of the device 700. As previously mentioned, an outside source can include another portion of the device.

After coupling through the window 714, the electromagnetic wave P_{f1} is received in the cavity 704. Plasmons having varying fields are stimulated on the inner surface 706. The cavity 704 can be sized to a resonant frequency f2. For example, an electromagnetic wave P_{f2} can carry the signal 742 and have a particular frequency distribution over a range of frequencies centered about a frequency f2 is generated in cavity 704. Similar to windows 713 and 714, window 715 can be made to can selectively pass or couple the electromagnetic wave P_{f2}.

The collector 733 coupled to window 715 receives the electromagnetic wave P_{f2} carrying the signal 742. A wave coupler 735 coupled to the collector 733 next receives the electromagnetic wave P_{f2}, which can now be coupled to another location, such as another location on the device 700.

By now it should be appreciated that a method and device are provided that uses a window portion of a wall for coupling a signal. The device can be formed by the wall on a major surface of a substrate. The thickness of the window portion of the wall is substantially less than the wall. A combination of materials and thicknesses used for making the window portion of the wall can provide for filtering an electromagnetic wave used to carry the signal. Wave couplers can be used to couple the signal between cavities making up the device or between cavities of different devices.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A device for coupling an electromagnetic wave, comprising:
a substrate;
a wall disposed on the substrate, the wall defining a resonant cavity to the electromagnetic wave at at least one frequency between 0.1 THz and 7 PHz, and having an electrically conductive inner surface; and
a window formed in the wall, and having a portion of the window adjacent to the cavity comprising at least a portion of the inner surface, wherein the electromagnetic wave is transmitted through the window to the cavity to induce resonance in the cavity.

2. The device of claim 1, wherein the window comprises a thickness less than a penetration depth of the window.

3. The device of claim 1, wherein the window comprises a thickness greater than a penetration depth of the window.

4. The device of claim 1, wherein the window comprises a thickness generally equal to a penetration depth of the window.

5. The device of claim 1, wherein the window is generally transparent.

6. The device of claim 1, wherein the window is translucent.

7. The device of claim 1, wherein the inner surface is flush with the window portion of the inner surface.

8. The device of claim 1, wherein the inner surface comprises a step that connects to the window portion of the inner surface.

9. The device of claim 1, wherein the wall comprises a material having an interaction with plasmons.

10. The device of claim 9, wherein the material is a metal selected from the group of metals consisting of gold, silver, copper and aluminum.

11. The device of claim 1, wherein the transmittance of the window ranges from about 1 percent to about 99 percent.

12. The device of claim 1, further comprising a focusing device operatively associated with the window.

13. The device of claim 12, further comprising a wave coupler operatively associated with the focusing device.

14. The device of claim 13, further comprising a second window.

15. The device of claim 14, wherein the wave coupler is coupled to the second window.

16. The device of claim 1, wherein the window comprises a plurality of windows.

17. The device of claim 1, wherein the wall comprises a micro-structure.

18. The device of claim 1, wherein the wall comprises a micro-resonant structure.

19. The device of claim 1, wherein the wall comprises a portion of a microcircuit.

20. A method for coupling a signal, comprising:
providing a wall disposed on a substrate, the wall defining a resonant cavity to the signal and having an electrically conductive inner surface;
forming a window in the wall, and having a portion of the window adjacent to the cavity comprising at least a portion of the inner surface; and
transmitting an electromagnetic wave carrying the signal through the window to the cavity to induce resonance in the cavity.

21. The method of claim 20, further comprising providing energy to an outer surface of the wall and using the energy to stimulate plasmons having varying fields.

22. The method of claim 21, wherein using the energy to stimulate the plasmons comprises coupling the plasmons and the varying fields through the wall to the inner surface and generating the electromagnetic wave in the cavity.

23. The method of claim 22, wherein transmitting the electromagnetic wave through the window comprises passing the electromagnetic wave through the window and out of the cavity.

24. The method of claim 20, wherein transmitting the electromagnetic wave through the window comprises receiving the electromagnetic wave through the window into the cavity and onto the inner surface.

25. The method of claim 24, wherein receiving the electromagnetic wave comprises stimulating plasmons having varying fields on the inner surface.

26. The method of claim 25, wherein stimulating the plasmons comprises coupling the plasmons and the varying fields through the wall to provide energy on an outer surface.

27. The method of claim 20, wherein providing the window comprises filtering to limit first and second frequency ranges that pass through the window.

28. The method of claim 27, wherein coupling the electromagnetic wave comprises passing a first electromagnetic waves having a first frequency range through the window into the cavity and onto the inner surface.

29. The method of claim 28, further comprising providing energy to an outer surface and coupling the energy through the wall and onto the inner surface.

30. The method of claim 29, wherein transmitting the electromagnetic wave through the window and coupling the energy through the wall comprises stimulating plasmons having varying fields on the inner surface.

31. The method of claim 30, wherein stimulating the plasmons comprises generating a second electromagnetic wave having a second frequency range.

32. The method of claim 31, wherein generating the second electromagnetic wave comprises transmitting the second electromagnetic wave through the window and out of the cavity.

33. The method of claim 20, wherein providing the window comprises filtering to limit the first and second frequency ranges that pass through the window.

34. The method of claim 33, wherein transmitting the electromagnetic wave comprises passing a first electromagnetic waves having a first frequency range through the window into the cavity and onto an inner surface.

35. The method of claim 34, wherein passing the first electromagnetic wave comprises stimulating plasmons having varying fields on the inner surface.

36. The method of claim 35, wherein stimulating the plasmons comprises generating a second electromagnetic wave having a second frequency range and coupling energy through the wall and to an outer surface.

37. The method of claim 36, wherein generating the second electromagnetic wave comprises passing the second electromagnetic wave through the window and out of the cavity.

38. A method for coupling a signal, comprising:
providing a wall disposed on a substrate, the wall defining a cavity having an electrically conductive inner surface;
providing first and second windows disposed in the wall, and having a portion of at least one of the first and second windows adjacent to the cavity and comprising at least a portion of the inner surface, said first and second windows filtering to limit first and second frequency ranges through the first and second windows, respectively; and
transmitting an electromagnetic wave carrying the signal through the first and second windows.

39. The method of claim 38, further comprising providing energy to an outer surface of the wall and using the energy to stimulate plasmons having varying fields.

40. The method of claim 39, wherein using the energy to stimulate the plasmons comprises coupling the plasmons and the varying fields through the wall to the inner surface and generating first and second electromagnetic waves having respective first and second frequency ranges.

41. The method of claim 40, wherein generating the first and second electromagnetic waves comprises passing the first and second electromagnetic waves out of the device through the first and second windows, respectively.

42. The method of claim 38, wherein transmitting the electromagnetic wave comprises receiving first and second electromagnetic waves having the first and second frequency ranges, respectively.

43. The method of claim 42, wherein receiving the first and second electromagnetic waves comprises passing the first and second electromagnetic waves through the respective first and second windows into the cavity and onto the inner surface.

44. The method of claim 43, wherein passing the first and second electromagnetic waves comprises stimulating plasmons having varying fields on the inner surface.

45. The method of claim 44, wherein stimulating the plasmons having varying fields comprises coupling energy through the wall to an outer surface.

46. The method of claim 38, wherein transmitting the electromagnetic wave comprises receiving a first electromagnetic waves having a first frequency range through the first window into the cavity and onto the inner surface.

47. The method of claim 46, further comprising providing energy to an outer surface and coupling energy through the wall and onto the inner surface.

48. The method of claim 47, wherein receiving the first electromagnetic wave and coupling the energy through the wall comprises stimulating plasmons having varying fields on the inner surface.

49. The method of claim 48, wherein stimulating the plasmons comprises generating a second electromagnetic wave having a second frequency range.

50. The method of claim 49, wherein generating the second electromagnetic wave comprises passing the second electromagnetic wave through the second window and out of the cavity.

51. The method of claim 50, wherein filtering to limit the first and second frequency ranges comprises respectively transmitting through the first and second windows below and above a cutoff frequency, respectively.

52. The method of claim 38, wherein transmitting the electromagnetic wave comprises receiving a first electromagnetic waves having a first frequency range through the first window into the cavity and onto the inner surface.

53. The method of claim 52, wherein passing the first electromagnetic wave comprises stimulating plasmons having varying fields on the inner surface.

54. The method of claim 53, wherein stimulating the plasmons comprises generating a second electromagnetic wave having a second frequency range and coupling energy to an outer surface.

55. The method of claim 54, wherein generating the second electromagnetic wave comprises passing the second electromagnetic wave through the second window and out of the cavity.

56. The method of claim 55, wherein filtering to limit the first and second frequency ranges comprises respectively transmitting through the first and second windows below and above a cutoff frequency, respectively.
